(19) United States
(12) Patent Application Publication
(10) Pub. No.: US 2019/0375608 A1
(43) Pub. Date: Dec. 12, 2019

(54) LIFT SYSTEM AND METHOD FOR OPERATING AN ELEVATOR SYSTEM

(71) Applicants: thyssenkrupp Elevator AG, Essen (DE); thyssenkrupp AG, Essen (DE)

(72) Inventors: Thomas KUCZERA, Leinfelden-Echterdingen (DE); Michael KIRSCH, Kirchheim unter Teck (DE); Christoph PAWELSKI, Dresden (DE); Jens KRZYWINSKI, Dresden (DE); Frank MÜHLBAUER, Dresden (DE)

(73) Assignees: thyssenkrupp Elevator AG, Essen (DE); thyssenkrupp AG, Essen (DE)

(21) Appl. No.: 16/487,320

(22) PCT Filed: Feb. 1, 2018
(86) PCT No.: PCT/EP2018/052534

§ 371 Date: Aug. 20, 2019

(30) Foreign Application Priority Data
Feb. 22, 2017 (DE) 10 2017 202 893.9

(51) Int. Cl. B66B 1/28; B66B 9/00; B66B 3/00; B66B 1/34

(52) U.S. Cl. CPC B66B 1/28; B66B 9/003; B66B 5/0025; B66B 1/3461; B66B 3/002

(57) ABSTRACT

A method for operating an elevator system including at least one elevator car for conveying people from a starting stop to a destination stop, wherein a route for conveying the people from the starting stop to the destination stop is determined. In this case, different elevator components of the elevator system are actuated in order to move the at least one elevator car along the determined route, as a result of which actions of these elevator components are triggered. Specific elevator components are selected from amongst these elevator components of the elevator system, and the actions of the selected elevator components are simulated by means of a reproduction apparatus located in the at least one elevator car. The disclosure further relates to an elevator system which is designed for executing a method of this kind.

The invention relates to a method for operating an elevator system comprising at least one elevator car for conveying people from a starting stop to a destination stop, wherein a route for conveying the people from the starting stop to the destination stop is determined. Elevator components of the elevator system are actuated in order to move the at least one elevator car along the determined route, wherein actions of these elevator components are triggered by the actuation of the elevator components. The invention further relates to an elevator system which is designed for executing a method of this kind.

The prior art discloses a large number of methods of this kind and also corresponding elevator systems. Said prior art discloses, in particular, elevator systems in which elevator cars are moved hydraulically or by means of a rope/belt drive or by means of a linear motor drive.

In this case, the present invention is targeted in particular at so-called multiple-car elevator systems in which a plurality of elevator cars can be moved largely independently of one another in an elevator shaft, in particular by means of a linear motor drive. In elevator systems of this kind, elevator cars can also be moved horizontally in particular. As a result, it is possible, in particular, to change between elevator shafts of an elevator system, so that an elevator system can, in particular, also be operated in a so-called circulation mode in which elevator cars are moved only in one single prespecified direction in an elevator shaft. The changing between elevator shafts is realized by means of a shaft-changing unit in this case. An elevator system of this kind and a method for operating an elevator system of this kind are known, for example, from DE 10 2014 201 804 A1.

Since, in particular, more modern elevator systems of this kind, in particular multiple-car elevator systems with a linear motor drive, which also allow the direction of travel of the elevator cars to be changed, for example from vertical travel to horizontal travel, are still largely unknown to elevator users, elevator users sometimes feel uneasy and uncomfortable. In addition, changes in the direction of travel may come as a surprise to an elevator user for example. This can lead to elevator users losing their balance and there is therefore a risk of injury.

In order to reduce a risk of injury in such cases, DE 10 2014 117 373 A1 proposes that the changing of the elevator car from a first transportation path to a second transportation path is indicated in the elevator car. To this end, arrows which indicate the direction of travel are displayed in the elevator car. If, for example, an elevator car is moved horizontally to the left, an arrow points to the left. If the direction of travel then changes and the elevator car is moved vertically upward, the arrow display in the elevator car changes and an arrow accordingly points upward.

As a result, the user is informed that the transportation path and therefore the direction of travel of the elevator car are changing. However, the elevator user continues to remain unaware of further operations of the elevator system which can also have an effect on the elevator car. For example, an elevator user may not recognize, for example, noises of the elevator system perceivable in the elevator car or vibrations occurring in the elevator car. As a result, the well-being of the elevator user and therefore the comfort when using elevator systems of this kind may suffer. The acceptance of elevator systems of this kind may also be reduced.

Against this background, one problem addressed by the present invention is to provide an improved method for operating an elevator system and an improved elevator system. In particular, the intention here is to improve the well-being of the elevator user when being conveyed by means of an elevator car of the elevator system.

A method for operating an elevator system and an elevator system as claimed in the independent claims are proposed for solving this problem. Further advantageous refinements of the invention are described in the dependent claims and the description and shown in the figures.

The proposed solution provides a method for operating an elevator system comprising at least one elevator car, in particular comprising a plurality of elevator cars, for conveying people from a starting stop to a destination stop. In so doing, a route for conveying the people from the starting stop to the destination stop is determined. Elevator components of the elevator system are actuated, in particular by means of a centralized or decentralized control system, in order to move the at least one elevator car along the determined route. Actions of these elevator components are triggered by the actuation of the elevator components. Specific elevator components of the elevator system are selected, and the actions of the selected elevator components are simulated by means of a reproduction apparatus located in the at least one elevator car. In this case, simulation of the actions of the selected elevator components is, in particular, a simulation of these actions.

Owing to the simulation of the actions of the selected elevator components within the elevator car, people located in the elevator car can advantageously comprehend what the elevator system is currently doing and/or will do. That is to say, the elevator system advantageously delivers a report to people located in the elevator car about actions which elevator components of the elevator system execute in order to move an elevator car of the elevator system from a starting stop to a destination stop. Therefore, people located in the elevator car can advantageously assign noises, vibrations or other changes which are perceivable in the elevator car to the corresponding actions of the respective active elevator components. As a result, the unease of elevator users in respect of the perception of noises, vibration and/or other changes which occur is advantageously reduced and therefore the well-being of the elevator users when using an elevator system of this kind is increased.

The simulation of actions of elevator components which run in the background and generally cannot be noticed by an elevator user, such as the transmission of control instructions as such or the allocation of an elevator car to a destination call and further actions of elevator components which run at the program level of the control system, or else the switching of contactors should generally not be simulated. Simulation of actions of this kind should preferably be able to be performed only as part of servicing and/or maintenance work.

In particular, provision is made for the actions of the selected elevator components to be visualized by means of an optical reproduction apparatus located in the at least one elevator car. To this end, the at least one elevator car advantageously comprises a display on at least one inner wall, on which display the actions of the selected elevator components are simulated. In particular, provision is made here for the actions of the selected elevator components to be simulated. In this case, provision can be made for elevator components to be displayed in a simplified form. However, according to one variant refinement, provision is also made for the elevator components to be reproduced true to scale. In particular, provision can be made for actions of the elevator components, which actions are recorded by means of a camera, to be reproduced by means of the optical reproduction apparatus.

A visualization of this kind of the actions of elevator components firstly has the advantage that an elevator user located in the elevator car is shown illustrations of which actions are currently being carried out by the elevator system and therefore simple assignment of noises, vibrations or other perceivable effects to actions of the respective elevator components is possible. The well-being of the elevator users is advantageously greatly increased in this way.

A further advantageous effect of a visualization of this kind is that a particular aesthetic effect which differentiates an elevator system of this kind from other elevator systems is achieved by a visualization of this kind within the elevator car.

As an alternative or in addition, provision is made according to a further advantageous refinement for the actions of the selected elevator components to be acoustically simulated by means of an acoustic reproduction apparatus located in the at least one elevator car. To this end, at least one loudspeaker is preferably arranged in the interior of the elevator car. In this case, an acoustic simulation of the actions of the selected elevator components has the advantage that the simulation of the action of the elevator components is even more realistic. Furthermore, an acoustic simulation of the actions of the selected elevator components has the further advantage that said actions can be perceived by visually impaired elevator users too, and the positive effect of the simulation of actions of selected elevator components is therefore achieved for visually impaired elevator users too.

A further advantageous embodiment of the proposed method provides that at least one criterion for the selection of the elevator components can be prespecified. In particular, provision is made for elevator components to be selected when at least one of the following criteria is met:
an action of the elevator component causes a change in state of the at least one elevator car;
an action of the elevator component can be perceived, in particular acoustically and/or haptically perceived, by a person located in the at least one elevator car;
the elevator component has been assigned to the determined route;
an action of the elevator component deviates, when it is carried out, from a prespecification which is prespecified by a normal operation;
the elevator component is prespecified in a list of prespecifications.

In this case, a change in state of an elevator car of the elevator system is caused by any action of an elevator component which moves the elevator car from a current state to another state. In this case, changes in state are, in particular, a change in the traveling speed of the elevator car, a change in the direction of travel of the elevator car, opening or closing of doors of the elevator car, a switching of the elevator car from one elevator shaft to another elevator shaft. Elevator components of which the actions trigger changes in state of the elevator car of this kind or further changes in state of the elevator car are advantageously selected. These include, in particular, a drive unit, a brake unit, a door unit, a shaft-changing unit.

In respect of the criterion that elevator components have been assigned to the determined route, provision is made, in particular, for a selection of elevator components which have to be activated for the corresponding routes to be assigned to all possible routes from a starting stop to a destination stop beforehand. If, for example, a route does not provide for the elevator car to change shaft, a shaft-changing unit is not selected as an elevator component either. Elevator components, such as a drive unit, which are always required when moving the elevator component can also be assigned to a route only when the actions of these elevator components can be perceived by the elevator user from the starting stop to the destination stop when using the elevator car. If, for example, a route provides for a very uniform acceleration of the elevator car and very uniform braking of the elevator car, wherein the acceleration and the braking can be perceived by the elevator user but do not affect the elevator user in an unusual way, provision is made, in particular, for elevator components of this kind to likewise not be assigned to the determined route. Assignment of elevator components to corresponding routes can be realized, for example, by means of so-called look-up tables.

The criterion that an action of the elevator component deviates, when it is carried out, from a prespecification which is prespecified by a normal operation relates, in particular, to a further advantageous aspect of the present invention. Therefore, in particular, provision is made for actions of elevator components which do not work as intended to be simulated by a reproduction apparatus. This can advantageously assist service personnel when carrying out maintenance and/or repair work. In this case, the reproduction apparatus can be provided, in particular, by way of a mobile terminal of the service personnel. However, furthermore, this criterion also benefits the aspect of counteracting unease of elevator users. If, for example, the braking of the elevator car is associated with louder noises than is provided for during normal operation, the action of the corresponding elevator component can be simulated, so that it is clear to the elevator user that the perceived noise is associated with an elevator component and there is no reason for unease in this respect.

According to a very simple refinement, provision is made, in particular, for a number of elevator components to be prespecified in a list of prespecifications and for the elevator components to be selected only in accordance with this list of prespecifications. In this case, the list of prespecifications is preferably stored in a memory unit which can be accessed by the elevator system or a control system of the elevator system.

A further particularly advantageous refinement of the proposed method makes provision for specific actions of the selected elevator components to be selected, wherein only the selected actions of the selected elevator components are simulated. This advantageously reduces the number of actions simulated by means of the reproduction apparatus. If, for example, an elevator car is braked or accelerated by means of a drive unit of the elevator system in a manner which corresponds to normal operation, actions of this kind of elevator components are usually not perceived as unusual by an elevator user. Therefore, actions of this kind are advantageously not simulated. Unusual actions, or at least actions which are unusual for a user, such as the operation of a shaft-switching unit which causes changing of the elevator car from a first shaft to a further shaft, can in contrast be selected as an action in particular.

In particular, provision is made for an action of the selected elevator components to be selected when at least one of the following criteria is met:
the action causes a change in state of the at least one elevator car;
the action can be perceived by a person located in the at least one elevator car;
the action has been assigned to the determined route;
the action deviates, when it is carried out, from a prespecification which is prespecified by a normal operation of the elevator car;
the action is prespecified in a list of prespecifications.

The statements made in respect of the criteria for the selection of the elevator components correspondingly applying in respect of the above criteria.

According to a further advantageous refinement of the proposed method, the actions of the selected elevator components are simulated at the same time as the triggered action of the respective selected elevator component is respectively carried out. That is to say, when an elevator component of the elevator system executes an action, for example the shaft-changing unit is operated, this action is simulated synchronously by means of the reproduction apparatus in the at least one elevator car of the elevator system. The elevator user located in the elevator car advantageously detects the corresponding simulation by means of the reproduction apparatus within the elevator car at the same time as the execution of an action of an elevator component of the elevator system. Therefore, the elevator user can advantageously comprehend what is currently happening with the elevator car in real time. Unease on account of noises, vibration and the like which cannot be recognized without corresponding simulation are therefore advantageously largely reduced. Furthermore, the traveling experience for the elevator user when using an elevator system of this kind is advantageously enhanced.

A further advantageous refinement makes provision for the actions of the selected elevator components to be simulated with a predetermined time lead in relation to the triggered action of the respective selected elevator component actually being carried out. Provision is advantageously made for the time lead to be able to be prespecified, in particular even depending on the elevator component which is executing the action, and/or depending on the action as such. The time lead can be, in particular, between one second and fifteen seconds. The time lead is advantageously between two and five seconds.

Owing to the time lead, the elevator user advantageously knows in advance which elevator components will execute which actions and can prepare for them in a corresponding manner. An increase in safety is advantageously achieved in this way. If, for example, a change in direction of travel of the elevator car is intended to be made, the corresponding action of the elevator component which is involved in the change in direction of travel is simulated with the predetermined time lead. The elevator user can respond to this in a corresponding manner and, for example, hold on to a handrail which is arranged in the elevator car.

Owing to the simulation of actions of elevator components which directly or indirectly affect the movement of an elevator car of the elevator system in which an elevator user is located, the “behavior” of the elevator car is advantageously easier to comprehend. For example, particularly in the case of a multiple-car elevator system, it may be the case that an elevator car cannot arrive at the destination stop yet since said destination stop is still occupied by another elevator car. For this reason, the car in question has to wait or at least continue to be moved at a reduced speed. In this case, the further elevator car waiting at the destination stop is advantageously simulated by means of the reproduction apparatus located in the elevator car in question. As a result, the need for his or her elevator car to wait or move slowly is advantageously made clear to the elevator user. Furthermore, the departure of the further elevator car from the destination stop is advantageously simulated by means of the reproduction apparatus.

A further advantageous refinement of the proposed method makes provision for a communication connection to be established between the elevator system and a mobile terminal, in particular a smartphone, wherein the specific elevator components are selected by means of the mobile terminal. As a result, the experience of using the elevator system is advantageously further enhanced for an elevator user. For example, the elevator user can learn, in particular, about the technology of the elevator system. For this purpose, a corresponding application is advantageously stored in a memory unit of the mobile terminal such that it can be executed. The communication connection between the mobile terminal and the elevator system is advantageously established in a wireless manner, in particular in accordance with a known radio network standard. To this end, the elevator system advantageously comprises a corresponding transmitter/receiver unit. Owing to this proposed refinement of the method, it is furthermore advantageously made easier to carry out servicing/maintenance work on the elevator system. In this case, maintenance personnel can in particular select by means of the mobile terminal elevator components which have to be routinely checked or which they suspect need to be replaced. Furthermore, provision is made, in particular, for the actions of the selected elevator components to be able to be simulated within the elevator car by means of a reproduction device of the mobile terminal.

According to a further advantageous aspect, the actuation of the selected elevator components is signaled to the reproduction apparatus. The actions of the selected elevator components are advantageously simulated in the event of successful signaling. In particular, provision is made for the control system, which actuates the selected elevator components for moving the elevator cars, to signal the actuation of the selected elevator components to the reproduction apparatus of the at least one elevator car. This all but ensures that actions of elevator components can be simulated when the corresponding elevator component of the elevator system is actually actuated.

At least one of the elevator components listed below is advantageously selected: shaft-changing unit, door unit, brake unit, drive unit, elevator car traveling in front, elevator car traveling behind, safety catch apparatus. In this case, provision is made, in particular, for the operation of the shaft-changing unit, in order to shift the elevator car, with which an elevator user is moved from a starting stop to a destination stop, to another transportation path and therefore to complete a shaft change, to be simulated by means of the reproduction apparatus which is located in said elevator car. Provision is further made, in particular, for actions of the door unit, in particular opening and closing of the doors of the elevator car, to be simulated by means of the reproduction apparatus. Provision is further made, in particular, for an activation of that brake unit of the elevator system which is responsible for the elevator car to be simulated by means of the reproduction apparatus located in the elevator car. Provision is further made, in particular, for the operation of that drive unit of the elevator system which is responsible for the elevator car to be simulated by means of the reproduction apparatus located in the elevator car. If the elevator system comprises a belt/rope drive, in this case provision is made, in particular, for increasing and/or reducing of the rotation speed of the drive machine to be simulated by means of the reproduction apparatus located in the elevator car. If the elevator cars of the elevator system are driven by means of a linear motor drive, provision can be made, in particular, for simulating by means of the reproduction apparatus those sections of the linear motor drive which are activated. If an elevator user to be moved from a starting stop to a destination stop is located in an elevator car, provision is further made, in particular, for an elevator car traveling in front of and/or traveling behind the elevator car in question to be simulated by means of the reproduction apparatus, in particular when actions of these elevator cars traveling behind and/or traveling in front influences the movement of the elevator car in question. Influencing of this kind can take place, in particular, by way of a safety distance from said elevator cars having to be maintained or the arrival at the destination stop being delayed because the destination stop is still occupied by an elevator car traveling in front. Provision is further made, in particular, for the activation of the safety catch apparatus of an elevator car to be simulated by means of the reproduction apparatus located in the elevator car. Since the triggering of the safety catch apparatus causes a sharp deceleration of the elevator car and consequently a certain risk of injury to the elevator user is associated with this, it is particularly advantageous when the activation of the safety catch apparatus is simulated with a predetermined time lead, in particular as early as possible, so that the elevator users can prepare for the sharp deceleration in an improved manner or at least be informed of the cause of the sharp deceleration, and therefore the well-being of the elevator users is improved.

A further advantageous refinement of the proposed method makes provision for actions of the elevator components to be detected by means of sensors, and for the actions which are detected by means of the sensors to be simulated by means of the reproduction apparatus. As a result, it is advantageously possible to exactly simulate how the correspondingly selected elevator component actually behaves. In particular, provision is made for cameras to also be used as sensors, and for the image data which is recorded by means of the camera to be transmitted to the optical reproduction apparatus within the elevator car and for the actions of the corresponding elevator components to be simulated by reproducing the recorded image data.

The solution further proposed in respect of the problem mentioned at the outset provides an elevator system comprising at least one elevator car which can be moved from a starting stop to a destination stop, wherein a reproduction apparatus is arranged in the interior of the at least one elevator car. In this case, the elevator system is designed for executing a method as described above.

In particular, provision is made for an optical reproduction apparatus to be arranged in the interior of the at least one elevator car, wherein the optical reproduction apparatus forms at least a portion of the inner wall of the at least one elevator car. In particular, provision is made for the optical reproduction apparatus to be a display, preferably an OLED display. Provision is further made, in particular, for the optical reproduction apparatus to form an entire inner wall of the at least one elevator car.

A further advantageous refinement of the proposed elevator system makes provision for an optical reproduction apparatus to be arranged in the interior of the at least one elevator car, wherein the optical reproduction apparatus forms a portion of an inner wall of the at least one elevator car and the remaining portion of this inner wall is of at least partially transparent design. In this case, the optical reproduction apparatus is preferably of round design, as a result of which a particularly advantageous esthetic effect is achieved. Owing to the transparent design of the remaining inner wall, a portion of the elevator system is advantageously clearly visible to a user located in the elevator car.

In particular, provision is made for the at least one elevator car to be connected to a rail system which allows movement of at least one elevator car in different spatial directions. In this case, the rail system advantageously comprises at least one shaft-changing unit which allows a change from one spatial direction to a further spatial direction. The reproduction apparatus which is arranged of the at least one elevator car in this case advantageously forms at least one portion of that inner wall of the elevator car which faces the rail system. Given a transparent design of a portion of the inner wall, the rail system can advantageously be seen here. In this case, the shaft-changing unit is advantageously displayed by means of the optical reproduction apparatus. This refinement is particularly advantageous in the case of a so-called “backpack solution”. In this solution, provision is made for a carriage to be able to be moved along the rail system, wherein the carriage comprises a receiving device which carries the elevator car. Owing to the carriage, the shaft-changing unit is not visible even given a transparent design of the inner wall which faces the rail system since the carriage is arranged between the rail system and the inner wall. In this respect, a simulation of the shaft-changing unit by means of the optical reproduction apparatus is particularly advantageous in a refinement of this kind. An elevator system with a “backpack solution” of this kind is known, for example, from WO 2015/144781 A1.

Further advantageous details, features and refinement specifics of the invention will be explained in more detail in connection with the exemplary embodiments which are illustrated in the figures, in which:

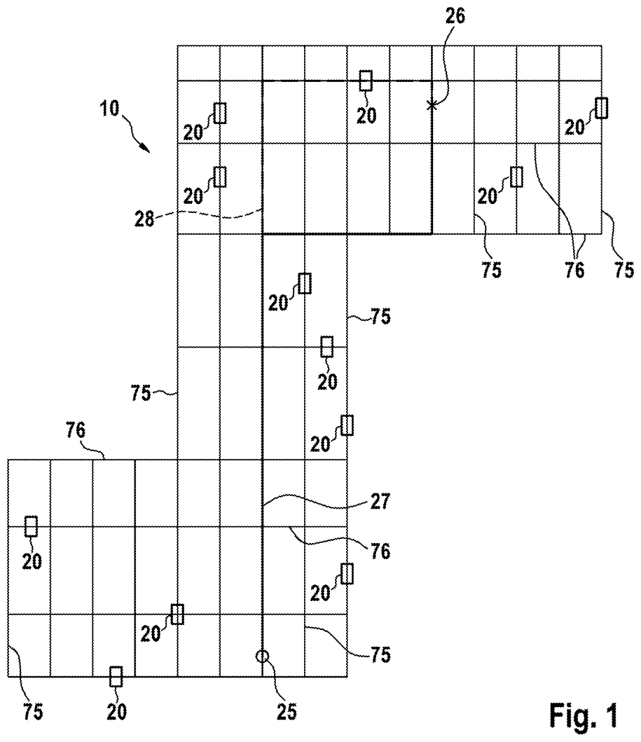

FIG. 1 shows a simplified schematic illustration of an exemplary embodiment of an elevator system which is operated in accordance with a variant refinement of a method which is designed according to the invention;

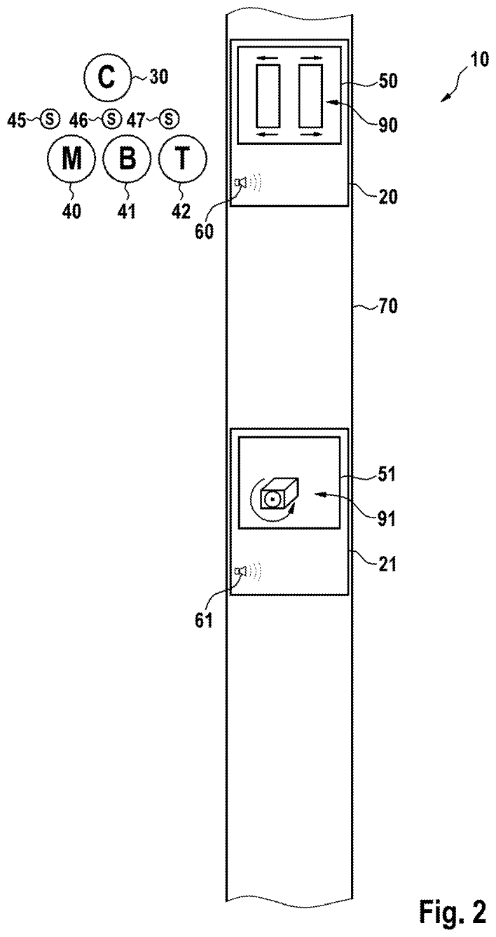

FIG. 2 shows a simplified schematic illustration of a detail of an exemplary embodiment of an elevator system which is configured according to the invention;

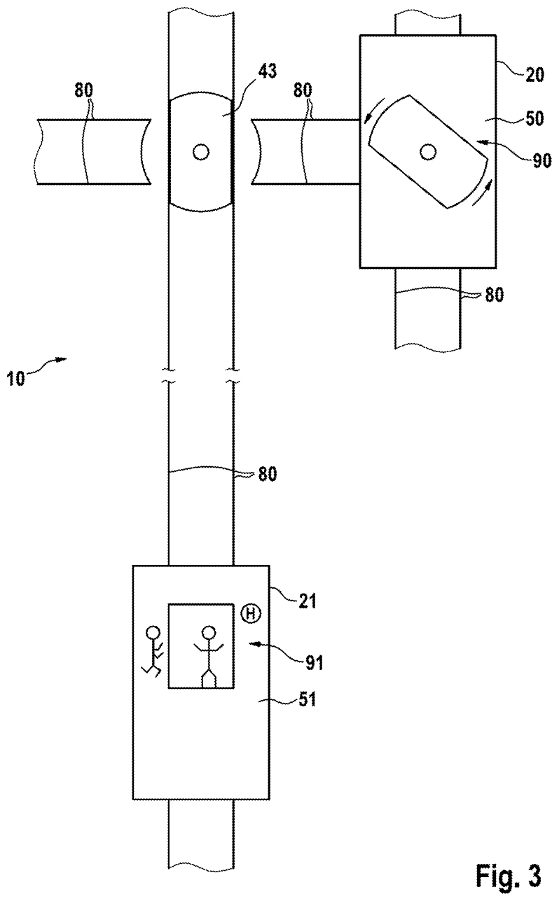

FIG. 3 shows a simplified schematic illustration of a detail of a further exemplary embodiment of an elevator system which is configured according to the invention; and

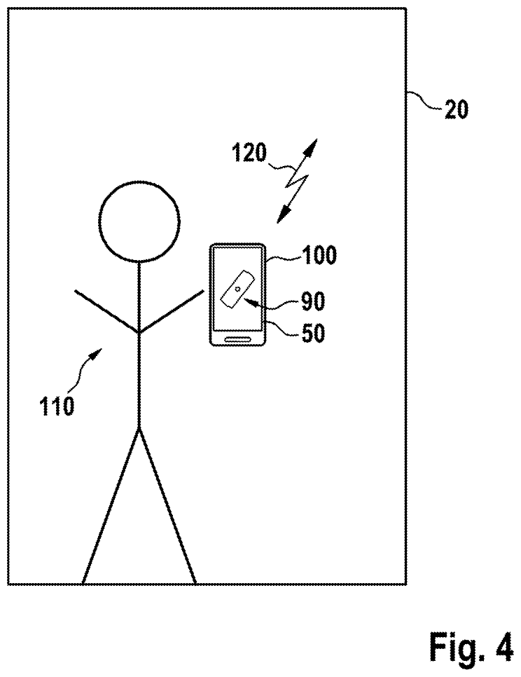

FIG. 4 shows a simplified schematic illustration of a detail of a further exemplary embodiment of an elevator system which is configured according to the invention.

The elevator system 10 which is schematically illustrated in FIG. 1 is an elevator system which is used, in particular, in so-called “high-rise” buildings, that is to say buildings with heights of several 100 meters. In this case, the elevator system 10 comprises a shaft system comprising a large number of vertical shafts 75 and horizontal shafts 76. In this case, a vertical shaft 75 or horizontal shaft 76 of this kind does not have to be structurally designed as a shaft. Instead, a vertical shaft 75 or horizontal shaft 76 of this kind can also be a rail or a pair of rails along which an elevator car 20 can be moved.

In this case, the elevator system 10 illustrated in FIG. 1 comprises a large number of elevator cars 20. People can be conveyed from a starting stop to a destination stop by means of the elevator cars 20. FIG. 1 illustrates, by way of example, a starting stop 25 and a destination stop 26.

In order to convey a person from a starting stop 25 to a destination stop 26 by means of an elevator car 20 of the elevator system 10, the elevator system 10 can comprise, in particular, a so-called destination call controller (not explicitly illustrated in FIG. 1). In the case of a destination call controller of this kind, the desired destination floor is input outside the elevator car 20, for example via an input terminal. The destination floor is then no longer input within the elevator car 20. However, provision is also made, in particular, for refinements of the elevator system 10 in which, particularly in the case of a starting floor with a so-called external call, an elevator car 20 is first requested and the destination floor is determined by way of a so-called internal call which is made within the elevator car 20.

Once the destination stop 26 has been determined, a route 27 for conveying the person from the starting stop 25 to the destination stop 26 is determined, in particular dynamically determined. In this case, dynamic determination of the route means that the route is not irreversibly defined once, but rather can be determined again and therefore changed during the movement of the elevator car 20 from the starting stop 25 to the destination stop 26, in particular due to transportation requests made by further people and the associated movement of the further elevator cars 20. For example, it is possible that the route 27 for moving an elevator car 20 from the starting stop 25 to the destination stop 26 had initially been determined and subsequently, in particular owing to a change in the traffic situation, the route 28 can be determined in order to reach the destination stop 26 from the starting stop 25.

In order that an elevator car 20 of the elevator system 10 can be moved along the intended route 27, 28, corresponding elevator components of the elevator system 10 have to be actuated. In the case of an elevator system 10 illustrated in FIG. 1, this actuation is performed, in particular, by means of a decentralized control system (not explicitly illustrated in FIG. 1). The elevator components which usually have to be actuated for moving an elevator car 20 of the elevator system 10 include, in particular, a drive unit, a shaft-changing unit, a brake unit and also a door unit (not explicitly illustrated in FIG. 1).

For example, a door unit is usually initially actuated, so that the doors to the elevator car 20 which is intended to move the person from a starting stop 25 to the destination stop 26 are opened at the starting stop 25. Once the person has entered, the door unit is actuated again, so that the doors close. For departure of the elevator car 20, actuation of the brake unit is required in particular, so that the brake which has held the elevator car 20 at the starting stop 25 is released. Furthermore, in particular, actuation of the drive unit is provided, so that the drive unit is activated and the elevator car 20 can be moved. In the case of the elevator system 10 illustrated in FIG. 1, the drive unit provided is, in particular, a linear motor drive. In the case of a linear motor drive of this kind, the corresponding rail sections of the shaft system of the elevator system 10 or the coils which are arranged along corresponding rail sections are advantageously correspondingly actuated in order to move the elevator car 20. If the elevator car 20 changes over from a vertical shaft 75 to a horizontal shaft 76, as is the case in the routes 27, 28 for example, a corresponding shaft-changing unit furthermore has to be actuated, so that said shaft-changing unit switches the elevator car 20 and thereby allows a change from one elevator shaft to another elevator shaft. Therefore, in summary, it can be said that corresponding actions of the respective elevator components, such as closing doors, releasing the brake etc., are triggered by the actuation of these elevator components.

In the case of the elevator system 10 illustrated in FIG. 1, provision is then made for specific elevator components of the elevator system 10 to be selected and the actions of the selected elevator components to be simulated by means of a reproduction apparatus (not explicitly illustrated in FIG. 1) located in the respective elevator cars 20. In the case of the elevator system illustrated in FIG. 1, provision is made in this case, in particular, for shaft-changing units of the elevator system 10 to be selected as elevator component. That is to say, when an elevator car 20 of the elevator system 10 is moved from a starting stop 25 to a destination stop 26 and a shaft-changing unit of the elevator system 10 is actuated and therefore operated in the process, so that the elevator car can change, for example, from a vertical shaft 75 to a horizontal shaft 76, the action of this shaft-changing unit is simulated in said elevator car 20, specifically only in this elevator car. If another elevator car of the elevator car is switched from one shaft to another shaft by means of said shaft-changing unit, this is simulated only in said other elevator car. The actions of the shaft-changing units of the elevator system 10 are preferably simulated by means of a display as an optical reproduction device (not explicitly illustrated in FIG. 1).

FIG. 2 shows a further exemplary embodiment of an elevator system 10. In this case, an elevator shaft 70 is illustrated, in which a first elevator car 20 and a second elevator car 21 are moved largely independently of one another. In this case, the elevator cars 20, 21 can be moved in the shaft 70 largely independently of one another, for example, with the aid of belt or rope drives (not explicitly illustrated in FIG. 2). An elevator system of this kind is known, for example, by the name TWIN® elevator. A configuration of an elevator system of this kind is described, for example, in EP 1 698 580 B1. As an alternative, provision can be made, in particular, for the elevator cars 20, 21 of the elevator system 10 to be moved in the elevator shaft 70 by means of a linear motor drive.

The elevator system 10 comprises, as symbolically illustrated in FIG. 2, a control system 30. This control system 30 controls, in particular, a large number of elevator components of the elevator system 10. The elevator components symbolically illustrated in FIG. 2 are a drive unit 40, a brake unit 41 and a door unit 42. The elevator cars 20, 21 themselves are also further components of the elevator system 10. Further elevator components, not explicitly illustrated in FIG. 2, can be, for example, rails along which the elevator cars 20, 21 are moved, terminals for placing calls, sensors for monitoring the area in front of the elevator system, sensors for monitoring the opening and closing of the shaft and car doors etc. Actions of these elevator components 40, 41, 42 are triggered by the actuation of the elevator components 40, 41, 42 of the elevator system 10 by means of the control system 30.

In the case of the elevator system 10 illustrated in FIG. 2, the drive unit 40, the brake unit 41 and the door unit 42 are selected as elevator components of the elevator system 10. The criterion for this selection is that actions of these elevator components 40, 41, 42 are usually perceived by people being conveyed from a starting stop to a destination stop by way of an elevator car 20, 21 of the elevator system 10, in particular owing to corresponding movements of the elevator car or of the doors of the respective door unit. As an alternative, these elevator components 40, 41, 42 can be prespecified in a memory unit of the elevator system 10 (not explicitly illustrated in FIG. 2), wherein only elevator components which are prespecified in this memory unit are selected.

In the case of the exemplary embodiment illustrated in FIG. 2 of an elevator system, an optical reproduction apparatus 50, 51, in particular an OLED display, is arranged in each of the elevator cars 20, 21 of this elevator system 10. An acoustic reproduction apparatus 60, 61, for example a loudspeaker, is further arranged in each of the elevator cars 20, 21 of this elevator system 10. Actions of the selected elevator components 40, 41, 42, which actions affect the respective elevator car 20, 21, are simulated by means of these optical reproduction apparatuses 50, 51 and acoustic reproduction apparatuses 60, 61. That is to say, in particular, that actions of selected elevator components 40, 41, 42 of this kind, which actions affect the elevator car 20, are visualized by means of the optical reproduction apparatus 50. Actions of the components 40, 41, 42, which actions affect the elevator car 20, are acoustically simulated by means of the acoustic reproduction apparatus 60 of the elevator car 20.

In the exemplary embodiment illustrated in FIG. 2, provision can be made, for example, for the elevator car 20 of the elevator system 10 to be at a stop, for example the destination stop, and for the doors of the elevator cars 20 to be opened. The door unit 42 is therefore executing an action. This opening of the doors of the door unit 42 is simulated by means of the optical reproduction apparatus 50. At the same time, a noise which acoustically simulates the opening of the doors of the door unit 42 is made by means of the acoustic reproduction apparatus 60. In this case, the door opening is simulated at the same time as the actual opening of the doors of the door unit 42 in this exemplary embodiment.

In particular, provision is made for sensors 45, 46, 47 to be assigned to the respective elevator components 40, 41, 42 in each case. In this case, these sensors 45, 46, 47 monitor the actions of these elevator components 40, 41, 42.

If, for example, the door unit 42 is actuated by means of the control system 30 of the elevator system 10, so that the doors of the door unit 42 open and access to the elevator car 20 is cleared, this is signaled to the optical reproduction apparatus 50 and the acoustic reproduction apparatus 60 at the same time. In this case, the sensor 47 detects the movement pattern of the doors of the door unit 42. The detected sensor signals of the sensor 47 are transmitted to the reproduction apparatuses 50, 60 of the elevator car 20 in this case. If the doors of the door unit 42 do not completely open as intended, for example on account of a technical fault, this is detected by means of the sensor 47. Since the sensor data is transmitted to the reproduction apparatuses 50, 60, the reproduction apparatuses 50, 60 will also simulate the incomplete opening of the doors of the door unit 42 in the simulation 90 of the door opening of the door unit 42.

In the case of the exemplary embodiment illustrated in FIG. 2, provision can further be made for the traveling speed of the elevator car 21 to have to be reduced on account of the elevator car 20 stopping. To this end, the control system 30 has to correspondingly actuate the drive unit 40 in order to reduce the drive speed. The corresponding action of the drive unit 40 is monitored by the sensor 45 in this case. In accordance with the detected signals of the sensor 45, a simulation 91 of the action of the drive unit 40 is performed by means of the optical reproduction apparatus 50 of the elevator car 21. In this case, the reduction in the speed of revolution of the drive unit 40 is, for example, schematically illustrated in the simulation 91. In this case, this action is not simulated by means of the acoustic reproduction apparatus 61.

FIG. 3 shows a further detail of an exemplary embodiment of an elevator system. FIG. 3 once again illustrates two elevator cars 20, 21 of an elevator system 10. In the case of this elevator system 10, the elevator cars 20, 21 are moved along rails 80 by means of a linear motor drive (not explicitly illustrated in FIG. 3). In this case, FIG. 3 illustrates vertically running rails 80, which form a vertical elevator shaft, and horizontally running rails 80, which form a horizontal elevator shaft. A shaft-changing unit 43, which is also referred to by the term “exchanger” in the prior art, is provided for changing from the vertical shaft to the horizontal shaft, or vice versa. Said shaft-changing unit is a rail section which can be rotated about an axis in order to allow either a movement of an elevator car along the vertical rail section or a movement of an elevator car along the horizontal rail section.

The elevator cars 20, 21 of the elevator system 10 illustrated in FIG. 3 are connected to the rails 80 by means of a carriage in accordance with the so-called “backpack solution” in this case. The inner wall of the elevator cars 20, 21, which inner wall faces the rails 80 in each case, is designed as an optical reproduction apparatus 50, 51 in this case.

In the exemplary embodiment shown in FIG. 3, the elevator car 20 is located exactly at a shaft-changing unit which is concealed by the elevator car 20. In order to change from the vertical shaft to the horizontal shaft, said shaft-changing unit has to be rotated. An action of this kind of the shaft-changing unit is associated with noise in this case. In addition, an action of this kind of the shaft-changing unit can lead to juddering phenomena and/or vibrations of the elevator car 20. In the case of a conventional elevator system, an elevator user may not recognize these noises and juddering phenomena and would accordingly feel uneasy as a result.

In the case of the elevator system 10 illustrated in FIG. 3, this is counteracted by way of the shaft-changing units 43 of the elevator system 10 being selected as elevator components, wherein actions of this shaft-changing unit 43 are simulated in the respective elevator cars 20, 21 by means of the optical reproduction apparatus 50, 51. In this case, the corresponding simulation is performed in the elevator car 20, 21 which is affected by the action of the shaft-changing unit 43. By way of example, FIG. 3 illustrates how the rotation of the shaft-changing unit 43 is simulated by way of a simulation 90 by means of the optical reproduction apparatus 50 of the elevator car 20. In this case, provision is made as an advantageous refinement for the simulation to be performed with a predetermined time lead, for example with a time lead of three seconds, before the actual action of the shaft-changing unit 43. As a result, an elevator user is advantageously made aware of the imminent action in good time. Since the operation of the shaft-changing unit 43 results in a change in the direction of travel of an elevator car, an elevator user can advantageously prepare for this owing to the early simulation and be sure to take a secure position in the elevator car.

In respect of the elevator car 21 of the elevator system 10, FIG. 3 illustrates a further exemplary embodiment of a simulation 91 of an action of an elevator component. In this exemplary embodiment, provision is made for the elevator car 21 to be intended to be moved downward, wherein a further elevator car, not explicitly illustrated in FIG. 3, prevents the elevator car 21 from traveling further downward. Therefore, the elevator car 21 has to make a stop and wait until the corresponding route, which is blocked by the further elevator car, is cleared. In order that this stoppage of the elevator car 21, the cause of which is not usually clear to an elevator user, is understood by the elevator user, provision is made for the stoppage of the further elevator car blocking the route to be simulated in a simulation 91 by means of the display unit 51. As a result, it is made clear to an elevator user in a simple manner that the elevator car 21 can only continue to be moved when the stoppage of the further elevator car is terminated. This is preferably likewise visualized by means of the reproduction apparatus 51.

It should be noted that provision is made, in particular, for not all actions of this further elevator car to be displayed as an elevator component by means of the reproduction apparatus 51. Provision is advantageously made for only selected actions of the further elevator car, which actions influence the movement of the elevator car 21, such as stoppages at stops along the route of the elevator car 21, to be simulated. Furthermore, according to one variant refinement, provision can be made for elevator components of which the actions are simulated by means of the reproduction apparatus in the elevator cars which are moved along this route to be prespecified for a specific route.

FIG. 4 shows, by way of example, an elevator car 20 of an elevator system. An elevator user 110 with a mobile terminal 100 is located in this elevator car 20. In this case, an optical reproduction device 50 is provided in the elevator car 20 by the mobile terminal 100, for example a smartphone. In this case, provision is made, in particular, for a communication connection 120 to be established between the mobile terminal 100 and the elevator system, not explicitly illustrated in FIG. 4. To this end, the elevator system advantageously comprises corresponding a transmitter/receiver unit.

The mobile terminal 100 advantageously comprises a program product which can be executed by means of the mobile terminal 100 and allows the mobile terminal 100 to communicate with the elevator system and to set up the communication connection. The communication connection 120 can be established in a wireless manner, for example as a WLAN or Bluetooth connection.

Once the communication connection 120 is established, the mobile terminal 100 can advantageously be used to select which actions of which elevator components should be simulated by means of the reproduction apparatus 50 of the mobile terminal 100. If the elevator car 20 is moved, for example, from a starting stop to a destination stop, the selected actions of the selected elevator components are reproduced in accordance with the prespecification made, and the selected actions of the selected elevator components are therefore simulated. If the elevator car 20 comprises a reproduction apparatus, the actions can alternatively or additionally be simulated by means of this reproduction apparatus. In this case, provision can be made, in particular, for cameras to monitor the elevator components and for the corresponding image data to be transmitted to the mobile terminal 100. This image data is then reproduced by means of the optical reproduction device 50 of the mobile terminal 100 in order to simulate the actions of the elevator components. In this regard, a configuration of this kind is also, in particular, an aid to servicing and maintenance personnel who have to make a repair or perform a maintenance service in the elevator system.

The exemplary embodiments illustrated in the figures and explained in conjunction with said figures serve to explain the invention and do not have a limiting effect on said invention.

### LIST OF REFERENCE SYMBOLS

10 Elevator system
20 Elevator car
21 Elevator car
25 Starting stop
26 Destination stop
27 Route
28 Route
30 Control unit
40 Drive unit
41 Brake unit
42 Door unit
43 Shaft-changing unit
45 Sensor
46 Sensor
47 Sensor
50 Optical reproduction device
51 Optical reproduction device
60 Acoustic reproduction device
61 Acoustic reproduction device
70 Elevator shaft
75 Vertical shaft
76 Horizontal shaft
80 Pair of rails
90 Simulation
91 Simulation
100 Mobile terminal
110 Elevator user
120 Communication connection

1.-15. (canceled)

16. A method for operating an elevator system comprising an elevator car for conveying people from a starting stop to a destination stop, the method comprising:
determining a route for conveying the people from the starting stop to the destination stop,
actuating elevator components of the elevator system to move the elevator car along the determined route,
triggering actions of the elevator components via actuation of the elevator components,
selecting specific elevator components of the elevator system, and
replicating the actions of the selected elevator components via a reproduction apparatus disposed at the elevator car.

17. The method of claim 16, including simulating the actions of the selected elevator components by:
visualizing the actions of the selected elevator components via an optical reproduction apparatus located at the elevator car; and
acoustically simulating the actions of the selected elevator components via an acoustic reproduction apparatus located at the elevator car.

18. The method of claim 16, including selecting the elevator components when at least one of the following criteria is met:
an action of the elevator component causes a change in state of the elevator car;
an action of the elevator component can be perceived by a passenger located in the elevator car;
the elevator component has been assigned to the determined route;
an action of the elevator component deviates, when it is carried out, from a prespecification which is prespecified by a normal operation; and
the elevator component is prespecified in a list of prespecifications.

19. The method of claim 16, including selecting specific actions of the selected elevator components and simulating only the selected actions of the selected elevator components.

20. The method of claim 19, including selecting an action of the selected elevator components when at least one of the following criteria is met:
the action causes a change in state of the elevator car;
the action can be perceived by a passenger located in the elevator car;
the action has been assigned to the determined route;
the action deviates, when it is carried out, from a prespecification which is prespecified by a normal operation; and
the action is prespecified in a list of prespecifications.

21. The method of claim 16, including simulating the actions of the selected elevator components at the same time as the triggered action of the respective selected elevator component is respectively carried out.

22. The method of claim 16, including simulating the actions of the selected elevator components with a predetermined time lead in relation to the triggered action of the respective selected elevator component actually being carried out.

23. The method of claim 16, including establishing a communication connection between the elevator system and a mobile terminal and selecting the specific elevator components via the mobile terminal.

24. The method of claim 16, including signaling the actuation of the selected elevator components to the reproduction apparatus and simulating the actions of the selected elevator components after successful signaling.

25. The method of claim 16, including selecting at least one of the following elevator components: a shaft-changing unit, a door unit, a brake unit, a drive unit, a second elevator car traveling in front of the elevator car, a second elevator car traveling behind the elevator car, and safety gear.

26. The method of claim 16, including detecting, by means of sensors, actions of the elevator components and simulating the detected actions via the reproduction apparatus.

27. An elevator system comprising an elevator car which is configured to be movable from a starting stop to a destination stop, wherein a reproduction apparatus is arranged in the interior of the elevator car, wherein the elevator system is configured to execute the method of claim 16.

28. The elevator system of claim 27, including an optical reproduction apparatus arranged in the interior of the elevator car and forms at least a portion of an inner wall of the elevator car.

29. The elevator system of claim 27, including an optical reproduction apparatus arranged in the interior of the elevator car and forms a portion of an inner wall of the elevator car and a remaining portion of this inner wall is of at least partially transparent design.

30. The elevator system of claim 28, wherein the elevator car is connected to a rail system which allows movement of the elevator car in different spatial directions, and the rail system comprises at least one shaft-changing unit which allows a change from one spatial direction to a further spatial direction, wherein the reproduction apparatus forms at least one portion of that inner wall which faces the rail system.
